(19) United States
(12) Patent Application Publication
(10) Pub. No.: US 2012/0129685 A1
(43) Pub. Date: May 24, 2012

(54) PROCESS FOR PREPARING MULTIMETAL CYANIDE COMPOUNDS

(75) Inventors: Jochen Mezger, Garching an der Alz (DE); Burkhard Walther, Garching (DE); Helmut Mack, Traunstein (DE); Simone Klapdohr, Rosenheim (DE); Zhizhong Cai, Trostberg (DE); Silke Flakus, Ebersberg (DE); Tobias Austermann, Muenster (DE); Bernhard Hoffner, Weinheim (DE); Wolfgang Rohde, Speyer (DE); Bernd Bechtloff, Ludwigshafen (DE); Michael Triller, Ilvesheim (DE); Sirus Zarbakhsh, Hong Kong Central (CN)

(73) Assignee: BASF SE, Ludwigshafen (DE)

(21) Appl. No.: 13/388,406

(22) PCT Filed: Aug. 11, 2010
(86) PCT No.: PCT/EP10/61654

§ 371 Date: Feb. 1, 2012

(30) Foreign Application Priority Data
Aug. 13, 2009 (EP) 09167814.4

(51) Int. Cl. B01J 27/26

(52) U.S. Cl. 502/175

(57) ABSTRACT

The invention relates to a process for preparing multimetal cyanide compounds by reacting the aqueous solution of a metal salt a) with the aqueous solution of a hexacyanometalate compound b), wherein the mixture of the solutions a) and b) flows over the surface of a rotating body A to an outer region of the surface of the rotating body A and is flung off from there.

The invention relates to a process for preparing multimetal cyanide compounds.

Multimetal cyanide compounds, frequently also referred to as DMC catalysts, have been known for a long time and are widely described in the literature, for example in U.S. Pat. No. 3,278,457 and U.S. Pat. No. 5,783,513.

Such compounds are preferably used as catalysts for preparing polyether alcohols by addition of alkylene oxides onto H-functional starter substances. These processes, too, are known.

The multimetal cyanide compounds are usually prepared by reacting the aqueous solution of a metal salt with the aqueous solution of a cyanometalate, frequently in the presence of at least one organic ligand. The multimetal cyanide compound obtained in this way is separated off, washed and dried.

Since the preparation of the multimetal cyanide compounds is complicated, there have been many attempts in the past to simplify the method of production. Thus, U.S. Pat. No. 5,891,818 describes a process for preparing multimetal cyanide compounds by combining a metal salt solution with the solution of a hexacyanometalate compound, with part of the reaction mixture being taken off and recirculated as spray via a nozzle into the reactor. This mode of operation is said to suppress foaming in the reactor and bring about better mixing of the reaction mixture. An in-line mixer by means of which the catalyst particles are broken up further as a result of shear forces, leading to a higher activity of the catalyst, is present in the circuit. However, this mode of operation is still complicated and blocking of the nozzle by catalyst particles can occur.

WO 01/39883 describes a process for preparing multimetal cyanide compounds, in which a metal salt solution is combined with the solution of a hexacyanometalate compound in a mixing nozzle. A disadvantage here is that particle formation can occur in the nozzle, leading to a pressure drop in the nozzle through to blockages.

WO 2006/037541 describes a process for the continuous preparation of multimetal cyanide compounds in a continuously operated stirred vessel. Here too, blockages can occur, in particular on discharge of the multimetal cyanide compounds from the stirred vessel.

It was an object of the present invention to develop a simple and economical process for the continuous preparation of multimetal cyanide compounds. The process should be able to be carried out in a simple way and ensure a good and reproducible product quality.

This object is achieved by a process for the continuous preparation of multimetal cyanide compounds by reaction of the aqueous solutions of a metal salt with a hexacyanometalate compound, with the mixture flowing over the surface of a rotating body A to an outer region of the surface of the rotating body A and being flung off from there.

The invention provides a process for preparing multimetal cyanide compounds by reacting the aqueous solution of a metal salt a) with the aqueous solution of a hexacyanometalate compound b), wherein the mixture of the solutions a) and b) flows over the surface of a rotating body A to an outer region of the surface of the rotating body A and is flung off from there.

The rotating body A can have a disk, vase, ring or cone shape, with a rotary disk which is horizontal or deviates from the horizontal by up to 45° being preferred. The body A normally has a diameter of from 0.10 m to 3.0 m, preferably from 0.20 m to 2.0 m and particularly preferably from 0.20 m to 1.0 m. The surface can be smooth or, for example, have flute-like or spiral depressions which influence the mixing and the residence time of the reaction mixture. The body A is preferably installed in a container which is resistant to the conditions of the process of the invention.

The rotational speed of the rotating body A and the metering rate of the mixture are variable. The rotational speed in revolutions per minute is usually from 1 to 20 000, preferably from 100 to 5000 and particularly preferably from 200 to 3000. The volume of the reaction mixture which is present on the rotating body A per unit area of the surface is typically from 0.03 to 40 ml/dm², preferably from 0.1 to 10 ml/dm², particularly preferably from 1.0 to 5.0 ml/dm². The average residence time (frequency average of the residence time spectrum) of the mixture is dependent, inter alia, on the size of the surface, on the type of compound and on the amount of water comprised, on the temperature of the surface and on the rotational speed of the rotating body A and normally in the range from 0.01 to 60 seconds, particularly preferably from 0.1 to 10 seconds, in particular from 1 to 7 seconds, and is thus to be considered to be extremely short. This ensures that the extent of possible decomposition reactions and the formation of undesirable products is greatly reduced and the quality of the substrate is thus maintained.

In a preferred embodiment of the invention, the preparation of the multimetal cyanide compound is carried out by means of an apparatus having
α) a body A rotating about a preferably central axis of rotation and
β) a metering system.

When carrying out the process of the invention, it can also be advantageous to pass the mixture a number of times over the surface of the rotating body A. In a further embodiment of the invention, the surface extends to further rotating bodies, so that the mixture goes from the surface of the rotating body A onto the surface of at least one further rotating body. The further rotating bodies are advantageously configured like the body A. The body A then typically feeds the further bodies with the reaction mixture. The reaction mixture leaves this at least one further body and can then be cooled if required by means of the quenching device.

Preference is given to the mixture being present in the form of a film having an average thickness in the range from 0.1 μm to 6.0 mm, preferably from 60 to 1000 μm and in particular from 100 to 500 μm, on the surface of the rotating body A.

The temperature of the rotating body A, in particular the surface facing the mixture, can be varied within a wide range and depends both on the substrates used, the residence time on the body A and on the pressure. Temperatures in the range from 5 to >100° C., particularly preferably from 25 to 120° C., in particular from 25 to 90° C., have been found to be advantageous. The mixture applied to the body A and/or the rotating body A can, for example, be heated electrically, by means of a heat transfer fluid, by means of steam, by means of a laser, by means of microwave radiation or by means of infrared radiation.

The process of the invention can be carried out at atmospheric pressure or slightly superatmospheric pressure and in an atmosphere of dry protective gas. However, it can also be advantageous to generate a reduced pressure, with, overall, pressures in the range from 0.01 mbar to 1100 mbar, particularly preferably from 1 mbar to 500 mbar, in particular from 10 mbar to 400 mbar, having been found to be advantageous. Furthermore, an advantageous embodiment of the present invention provides for the vaporized water being driven out by means of a gas or dry air, in particular inert gas.

The multimetal cyanide compounds prepared by the process of the invention preferably have the general formula (I)

M¹ₐ[M²(CN)_{b]}_{d}•fM³ⱼXₖ•h(H₂0)•eL•zP (I),

where
M¹ is a metal ion selected from the group consisting of Zn²⁺, Fe²⁺, Fe³⁺, Co²⁺, Co³⁺, Ni²⁺, Mn²⁺, Sn²⁺, Sn⁴⁺, Pb²⁺, Al³⁺, Sr²⁺, Cr³⁺, Cd²⁺, Cu²⁺, La³⁺, Ce³⁺, Ce⁴⁺, Eu³⁺, Mg²⁺, Ti⁴⁺, Rh²⁺, Ru²⁺, Ru³⁺, Pd²⁺,
M² is a metal ion selected from the group consisting of Fe²⁺, Fe³⁺, Co²⁺, Co³⁺, Mn²⁺, Mn³⁺, Ni²⁺, Cr²⁺, Cr³⁺, Rh³⁺, Ru²⁺, Ir³⁺
   and M¹ and M² are identical or different,
M³ is a metal ion selected from the group consisting of Zn²⁺, Fe²⁺, Fe³⁺, Co²⁺, Co³⁺, Ni²⁺, Mn²⁺, Sn²⁺, Sn⁴⁺, Pb²⁺, Al³⁺, Sr²⁺, Cr³⁺, Cd²⁺, Cu²⁺, La³⁺, Ce³⁺, Ce⁴⁺, Eu³⁺, Mg²⁺, Ti⁴⁺, Ag⁺, Rh²⁺, Ru²⁺, Ru³⁺, Pd²⁺
   and M¹ and M³ are identical or different, with the proviso that M¹, M² and M³ must not be identical,
X is an anion selected from the group consisting of halide, hydroxide, sulfate, hydrogensulfate, carbonate, hydrogencarbonate, cyanide, thiocyanate, isocyanate, cyanate, carboxylate, oxalate, nitrate and nitrite (NO₂—),
L is a water-miscible ligand selected from the group consisting of alcohols, aldehydes, ketones, ethers, polyethers, esters, polyesters, polycarbonate, ureas, amides, nitriles and sulfides and mixtures thereof,
P is an organic additive selected from the group consisting of polyethers, polyesters, polycarbonates, polyalkylene glycol sorbitan esters, polyalkylene glycol glycidyl ethers, polyacrylamide, poly(acrylamide-co-acrylic acid), polyacrylic acid, polyacrylamide-co-maleic acid), polyacrylonitrile, polyalkyl acrylates, polyalkyl methacrylates, polyvinyl methyl ether, polyvinyl ethyl ether, polyvinyl acetate, polyvinyl alcohol, poly-N-vinylpyrrolidone, poly(N-vinylpyrrolidone-co-acrylic acid), polyvinyl methyl ketone, poly(4-vinylphenol), poly(acrylic acid co-styrene), oxazoline polymers, polyalkyleneimines, maleic acid and maleic anhydride copolymers, hydroxyethylcellulose, polyacetates, ionic surface- and interface-active compounds, bile acids and salts thereof, esters and amides, carboxylic esters of polyhydric alcohols and glycosides,
   and
a, b, d, j, k, e, f, h and z are integers or fractions greater than or equal to zero,
   where
a, b, d, j, k are selected so that electrical neutrality is ensured.

Compounds of the general formula (I) in which M¹ is Zn²⁺ and M² is Co²⁺ or Co³⁺ are of particular practical importance.

Multimetal cyanide compounds prepared by the process of the invention can, depending on the starting materials and auxiliaries used and the production conditions, have different crystal structures. Thus, the multimetal cyanide compounds can have a crystalline or amorphous structure. Crystalline multimetal cyanide compounds are described, for example, in WO 99/16775, while amorphous multimetal cyanide compounds are described, for example, in EP 634 302.

Among the crystalline multimetal cyanide compounds, those having a monoclinic crystal structure are particularly preferred.

The multimetal cyanide compounds of the general formula (I) are, as indicated above, prepared by reacting a metal salt of the general formula M¹_{g}Xₙ with a cyanometalate compound of the general formula M⁴ᵣ[M²(CN)_{b}]_{d}. The reaction is usually carried out in an aqueous solution.

The symbols which have been mentioned above in the general formula (I) have the same meanings as in the formula (I). M⁴ can be hydrogen or a metal ion, preferably an alkali metal ion or an ammonium ion. Preference is given to M⁴ being hydrogen or a potassium ion.

In carrying out the process of the invention, the starting materials, i.e. metal salt a), hexacyanometalate compound b) and, if used, ligands and additives are mixed with one another. Here, metal salt and hexacyanometalate compound are usually present in the form of an aqueous solution.

Mixing of the components a), b) with the ligands and additives should take place before application to the rotating body A. This can, for example, be carried out continuously in a static mixer.

The components a) and/or b) can be heated if required before application to the rotating body A. This can also be carried out continuously.

Since the speed of the precipitation is very high, the solutions a) and b) are applied separately to the rotating body A and mixed there in a preferred embodiment of the process of the invention. The solutions can be applied to the same place on the rotating body A. In a preferred embodiment of the process of the invention, the solutions a) and b) are applied to different metering positions on the rotating body A and mixed there.

The metering positions on the rotating body A are not critical. They should be selected so that a complete reaction can occur and caking on the rotating body is minimized. In the simplest case, they can be applied at the same distance from the axis of rotation.

In a preferred embodiment of the process of the invention, the solution a) is applied at a shorter distance from the center of rotation of the rotating body A than the solution b). The distance of the two metering positions from the center of rotation should be such that no precipitation of the hexacyanometalate compound b) occurs before the metering position for the solution a) is reached.

To obtain a monoclinic crystal structure of the multimetal cyanide compounds, further metered application of the solution a) is preferably carried out. This should take place at a position which is closer to the edge of the rotating body A than the first metering position of the solution a) but far enough from the edge for complete reaction to be able to take place.

As described above, it is possible to add ligands and additives to one or both of the solutions a) and b).

It is also possible to apply ligands or additives to the rotating body at a separate metering position. This is preferably selected so that it is located between the first metering position of the solution a) and the edge of the rotating body A. It can also be located between the second metering position and the edge of the body A. In a preferred embodiment, the surface-active agent is applied together with the solution a) at the second metering position.

As described, the reaction is carried out on the rotating body A. The multimetal cyanide compound is flung off in the form of an aqueous suspension.

The material for the rotating body A should be selected so that caking of the multimetal cyanide compound is minimized. In addition, it should be inert toward the starting materials and end product of the process.

In an embodiment of the invention, the rotating body A can comprise plastic, for example a polyolefin such as polypropylene.

However, preference is given to using rotating bodies A composed of metal. These rotating bodies can be heated, which makes a better reaction possible. In particular, different temperatures can be set for the different metering positions.

In a preferred embodiment of the invention, the solution b) and the solution a) are applied to the rotating body A at the first metering position at temperatures of 10-30° C., preferably room temperature. If the solution a) is also applied to the rotating body A at a second metering position, this preferably has a higher temperature, preferably 45-65° C., in particular 50-60° C. Furthermore, it is advantageous to heat the periphery of the rotating body A to a temperature which is above the temperature of the solution a) applied at the second metering position. The temperature there is preferably in the range from 70 to 90° C., in particular from 75 to 85° C. The two-stage metered application is employed particularly when crystalline multimetal cyanide compounds having a monoclinic crystal structure are to be prepared.

As described above, the multimetal cyanide compound is flung off in the form of an aqueous suspension from the rotating body A. It is preferably flung against a wall which is arranged perpendicular to the rotating body A and from which the suspension can run downward.

The pulverulent multimetal cyanide compound can be used without further treatment as catalyst for the addition reaction of alkylene oxides.

It is also possible to suspend the multimetal cyanide compound in a solvent, in particular an alcohol or a polyether alcohol, and use it in this form as catalyst.

In a further embodiment, the suspension flung off from the rotating body A can be worked up further. Thus, it can be advantageous to stir the suspension further in order to improve the catalytic properties of the multimetal cyanide compound. The time for the further stirring is dependent on the desired parameters of the multimetal cyanide compound and is preferably from 1 to 3 hours. The temperature is preferably in the same range as at the second metering position on the rotating body A.

As described above, the multimetal cyanide compounds prepared by the process of the invention can preferably be used as catalysts for the polymerization of alkylene oxides.

The process of the invention allows a technically simple continuous production of multimetal cyanide compound. The rotating body A is robust and can be operated and cleaned easily. The reaction conditions and thus also the properties of the multimetal cyanide compounds can be varied in a simple way by varying speed of rotation, temperature and metering positions.

The invention is illustrated by the following examples.

### EXAMPLE 1

### Single-stage Reaction

A circular disk of aluminum which had a radius of 10 cm and could be heated by means of heat transfer oil was used.

The speed of rotation was 830, 1650 and 2250/min. The starting materials were applied 3, 5 and 8 cm from the midpoint of the disk. The mass flow was 5 and 18 liters of suspension per hour. The temperature of the starting solutions was 22° C., and the disk was not heated.

Zinc acetate and hexacyanocobaltic acid were used in the form of aqueous solutions as starting materials. The concentration of hexacyanocobaltic acid in the solution was 0.9% by mass of cobalt, and the concentration of zinc acetate in the solution was 2.6% by mass of zinc.

The suspension flung off from the disk was stirred further at 55° C. for two hours.

The primary particles were crystalline and had a size of 120-150 μm. It was found that the speed of rotation, metering position and mass flow did not have a significant influence on the size of the primary particles. Agglomeration of the particles decreased with increasing speed of rotation.

The multimetal cyanide compounds had a good catalytic activity.

### EXAMPLE 2

### Single-stage Preparation

The procedure of Example 1 was repeated, but a polypropylene disk was used in place of an aluminum disk.

The results corresponded to those in Example 1. It could therefore be seen that the material of the disk has no significant influence on the properties of the multimetal cyanide compounds.

### EXAMPLE 3

### Two-stage Metered Application

The same disk as in Example 1 was used, and the speeds of rotation and mass flows corresponded to those in Example 1. The solution of the hexacyanocobaltic acid was applied at the midpoint of the disk, the first partial amount of the zinc acetate was applied 3 cm from the midpoint and the second, equal-sized partial amount of the zinc acetate was applied 8 cm from the midpoint of the disk. The second partial amount of the zinc acetate comprised 50% by mass, based on the weight of the multimetal cyanide compound, of the surface-active agent Pluronic® from BASF SE.

The temperature of the solution of the hexacyanocobaltic acid and the first partial amount of the zinc acetate was 22° C., and that of the solution of the second partial amount of the zinc acetate was 55° C. The disk was heated to 75° C.

The suspension flung off from the disk was stirred further at 55° C. for two hours.

The average particle size was 10 μm.

The multimetal cyanide compounds had a good catalytic activity.

1. A process for preparing multimetal cyanide compounds by reacting the aqueous solution of a metal salt a) with the aqueous solution of a hexacyanometalate compound b), wherein the mixture of the solutions a) and b) flows over the surface of a rotating body A to an outer region of the surface of the rotating body A and is flung off from there.

2. The process according to claim 1, wherein the rotating body A is present as a rotary disk.

3. The process according to claim 1, wherein the temperature of the rotating body A is in the range from 5 to >100° C.

4. The process according to claim 1, wherein the speed of rotation of the rotating body A is from 1 to 20 000 per minute.

5. The process according to claim 1, wherein the aqueous solution a) is applied in two partial amounts.

6. The process according to claim 1, wherein the solution a) and/or b) comprises a surface-active agent.
